(19) United States
(12) Patent Application Publication
(10) Pub. No.: US 2009/0291178 A1
(43) Pub. Date: Nov. 26, 2009

(54) METHOD AND APPARATUS FOR CLEANING FROST-DAMAGED ARTICHOKES

(76) Inventor: Michael Scattini, Castroville, CA (US)

Correspondence Address: LARIVIERE, GRUBMAN & PAYNE, LLP, 19 UPPER RAGSDALE DRIVE, SUITE 200, MONTEREY, CA, 93940, US

(21) Appl. No.: 12/472,370

(22) Filed: May 26, 2009

Related U.S. Application Data
(60) Provisional application No. 61/055,808, filed on May 23, 2008.

(51) Int. Cl. A23B 7/00; A23L 1/212; A23N 15/00; A23N 15/06

(52) U.S. Cl. 426/483; 426/482; 15/3.1; 15/3.16

(57) ABSTRACT

A method and apparatus for cleaning frost-damaged artichokes is disclosed. Fluids, fluids under high pressure, mechanical devices, including but not limited to brushes, sponges, or any material that can apply a soft abrasion may, or a similar device may be applied to the damaged portions of an artichoke, thereby removing the damaged tissue and improving the appearance and/or life of the artichoke.

### CROSS-REFERENCE TO RELATED DOCUMENTS

This application is based on, incorporates by reference entirely, and claims priority to U.S. Provisional Patent Application Ser. No. 61/055,808, filed on May 23, 2008.

### TECHNICAL FIELD

The present invention relates to the field of agriculture. More specifically, the present invention relates to the field of artichoke production.

### BACKGROUND ART

Artichoke production may take place throughout the year. During the fall, winter, and spring seasons, artichoke production is extremely susceptible to damage from frost and freezing temperatures. As frost settles and forms on the artichoke it causes damage to the outer exposed areas of the bracts. This results from the formation of ice crystals within the plant tissue which causes detachment and destruction of plant cells. This damage manifests as an apparent scarring of the areas were the frost was present. The scarring can range from a layer of small white bumps varying in size and quantity to large brown/bronze layers covering large portions of the artichoke.

The severity of the damage is determined by multiple factors, including the following: how cold the temperatures reach, how long it takes for the artichoke to “thaw,” the number of consecutive days of frost, the level of moisture in the air and on the artichoke, how long the artichoke sits with the frost damage, and whether the artichoke gets wet after the frosting event. If frost damage is left untreated the severity of the damage can worsen, going from light white to a heavy brown/bronze appearance. Eventually the frost damage can cause decay and rot leading to a reduced shelf life and eventually the loss of product. Damage in appearance and shelf life reduces the marketability of frost damaged artichokes, resulting in decreased sales at the retail level and consequently a loss in revenue for both the retailer and producer of artichokes.

The unique nature of an artichoke, including its inherent attributes as a thistle, its unique shape including a stem coupled to a globe, and its many bracts, among many other characteristics, pose complications for a method and apparatus to improve the condition of the artichoke while helping to prevent further decay and spread of damage resulting from frost. Therefore, there is a need for a method and apparatus for improving the condition of artichokes that have been damaged by frost and/or freezing while taking into consideration the unique nature of artichokes.

### DISCLOSURE OF THE INVENTION

The present invention addresses the aforementioned problems related to frost or freeze damage of artichokes by providing a method and apparatus for cleaning away frost damaged portions of artichokes and thereby greatly improving the appearance of frost-damaged artichokes.

The present invention is drawn to a method and apparatus for removing portions of an artichoke that have been damaged by frost and/or freezing temperatures. Furthermore, the method and apparatus of the present invention also extends shelf life while improving the appearance of artichokes that have been damaged by frost and/or freezing temperatures. The improved appearance of artichokes treated in accordance with the present invention may increase the market value of artichokes that have been damaged by frost and/or freezing temperatures.

In an embodiment of the present invention, damaged portions of an artichoke are cleaned away by the application of a fluid under high pressure, and or via mechanical scrubbing. The fluid may be water, air, or some other fluid suitable for application under high pressure to a plant. The mechanical scrubbing may include brushes, sponges, cloth materials, any material that can apply a soft abrasion, or the like. The resulting improvement in the appearance of the frost-damaged artichoke thereby improves the marketability and shelf life of the product.

### BRIEF DESCRIPTION OF THE DRAWINGS

FIG. 1 is a flow diagram of a method for improving the condition of frost-damaged artichokes, in accordance with all embodiment of the invention.

FIG. 2 is a flow diagram of a method for improving the condition of frost-damaged artichokes, in accordance with an alternative embodiment of the invention.

FIG. 3 is a diagram of a device for cleaning frost-damaged artichokes, in accordance with an embodiment of the invention.

FIG. 4 is a diagram of an apparatus for cleaning frost-damaged artichokes, in accordance with an embodiment of the invention.

FIG. 5 is a diagram of an apparatus for cleaning frost-damaged artichokes, in accordance with an embodiment of the invention.

### BEST MODES FOR CARRYING OUT THE INVENTION

The present invention is drawn to a method and apparatus of cleaning away frost-damaged portions of an artichoke, thereby improving the artichoke's appearance and its marketability.

The method and apparatus of the present invention may include a variety of techniques, such as the use of pressurized fluids such as water or air, mechanical removal of frost damaged tissue, and a chemical addition to inhibit breakdown and decay. Pressurized water may be sprayed onto the globe, in varying levels of pressure depending on the severity of the frost damage; the angle of the spray may be determined by the size and shape of the artichoke. The amount of water and duration of contact may also vary based on the severity of damage. Pressurized air can also be used in place of water. Mechanical removal of frost-damaged areas can also be used. Such mechanical removal may utilize brushes, sponges, scrapers, rags, blades, cloth materials, any material that can apply a soft abrasion, or the like, to clean off the frost damage. The type of devices utilized for mechanical removal, length of application, length of brushing/sponging, duration and angle of brushes/sponge, and duration and angle of mechanical removal is also determined by the severity of the damage, and the size and shape of the artichoke. Artichokes can also be placed in a “bath” and then have one or all of these methods applied to the frost damaged artichoke within or outside the bath.

The method and apparatus of the present invention may include some or all of the foregoing techniques as deemed necessary based upon factors such as the condition of the artichoke, its size, or other factors. The following enumerated embodiments are merely representative of the many variations which may be devised in accordance with the present invention.

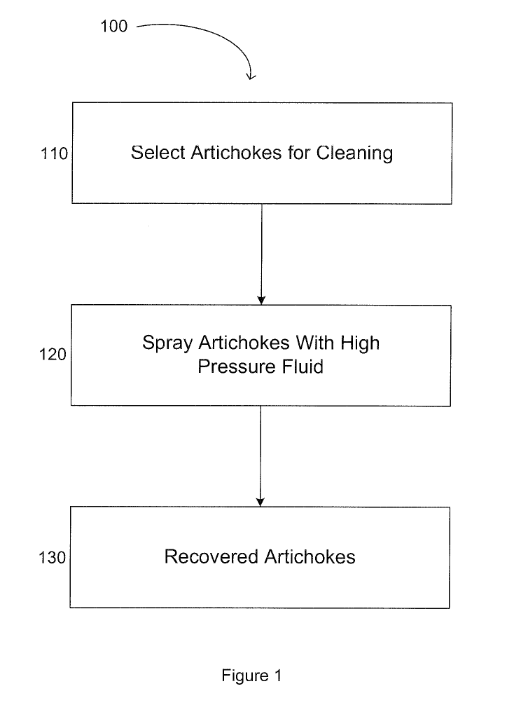

FIG. 1 illustrates a method 100 for improving the condition of frost-damaged artichokes, in accordance with an embodiment of the present invention. At step 110, one or more artichokes are selected for cleaning. The selection may take any form known in the art, such as by hand, via a conveyor system, an inclined feeder, a water bath system, etc. At step 120, the selected artichokes are sprayed with fluid having sufficient pressure to remove frost damaged tissue. The fluid sprayed may be water, a water based solution, air or any other fluid known in the art. The angle, strength and duration of spray may vary according to the condition of the artichoke, its size and shape, and the nature and extent of frost damage. At step 130, you have the recovered artichoke.

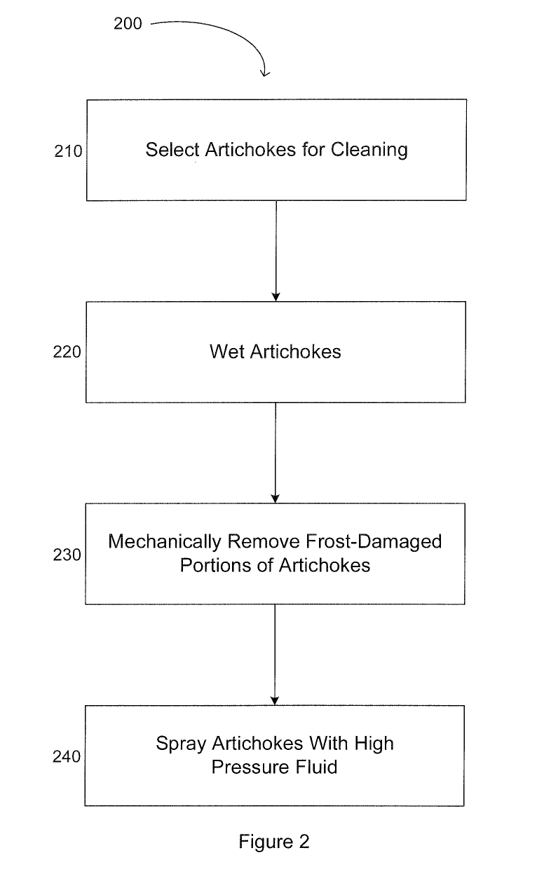

FIG. 2 illustrates a method 200 for improving the condition of frost-damaged artichokes, in accordance with an alternative embodiment of the present invention. At step 210, one or more artichokes are selected for cleaning. At step 220, the selected artichokes are wet by any method known in the art, such as spraying them with a water based fluid or submerging them in a water based solution. At step 230, the frost-damaged portions of the artichoke are mechanically removed. Such mechanical removal may be accomplished by the use of brushes, sponges, scrubbers, rags and cloth materials, any material that can apply a soft abrasion, or the like. At step 240, the selected artichokes may also be sprayed with a fluid under pressure to remove any superfluous material.

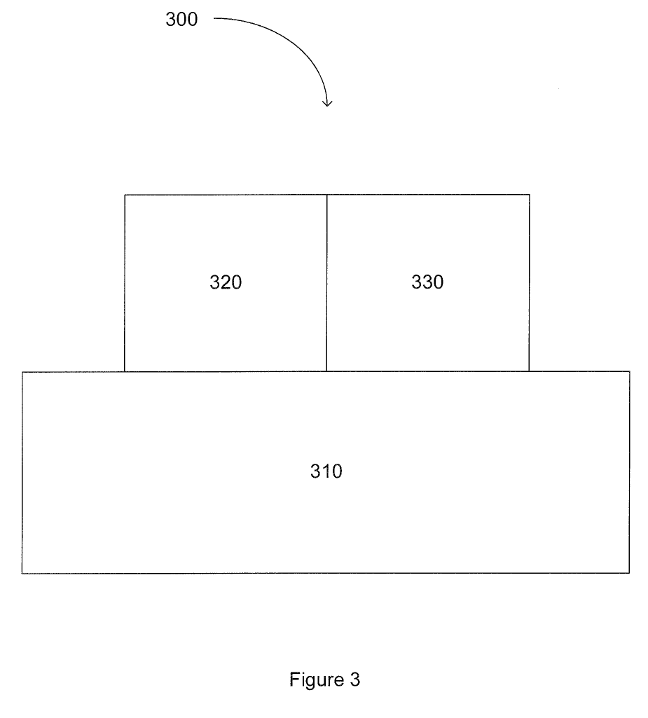

The foregoing techniques and methods may be performed in whole or in part by automated machinery, this being contemplated within the scope of the invention. In an alternative embodiment of the invention, a device 300 for cleaning and improving the condition of frost-damaged artichokes is herein disclosed, as shown in FIG. 3. The device 300 has a transporter 310 for positioning and moving artichokes through the cleaning section 320 and the treatment section 330. The conveyor section 310 may utilize any of a number of methods for positioning and moving food products known in the art, such as a series of sockets or holders in which artichokes are placed, a moving water bath, etc. Cleaning section 320 has an apparatus for spraying fluid under high pressure onto the artichoke so as to remove frost-damaged portions of the artichoke. Cleaning section 320 may have any type of spraying apparatus known in the art, such as an array of nozzles that may be fixed or movable. Cleaning section 320 may additionally or alternatively implement mechanical removal devices in addition to spraying apparatus. A treatment section 330 has an apparatus for treating the artichokes with a solution to prevent further decay. The treatment section 330 may have any type of treatment apparatus and solution known in the art, such as a spray wash, a bath, among others.

Steps of the above mentioned methods may alter in order or in kind. For example, frost-damaged portions of the artichoke may be removed before the artichoke is wet. Or mechanical removal of the frost-damaged portions of artichokes may be substituted for spraying the artichokes.

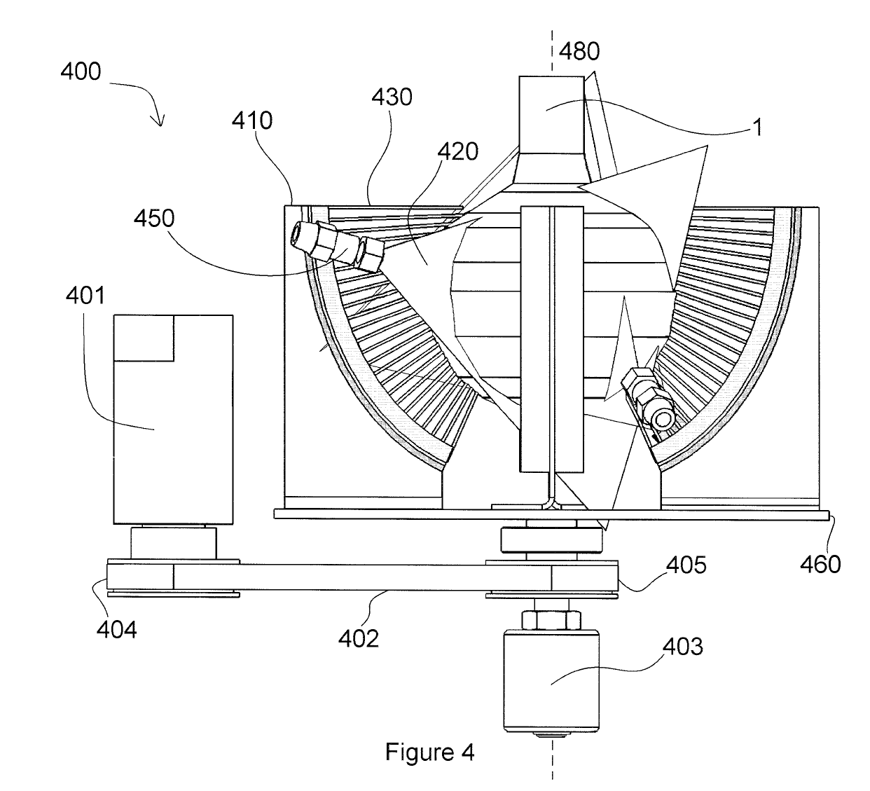

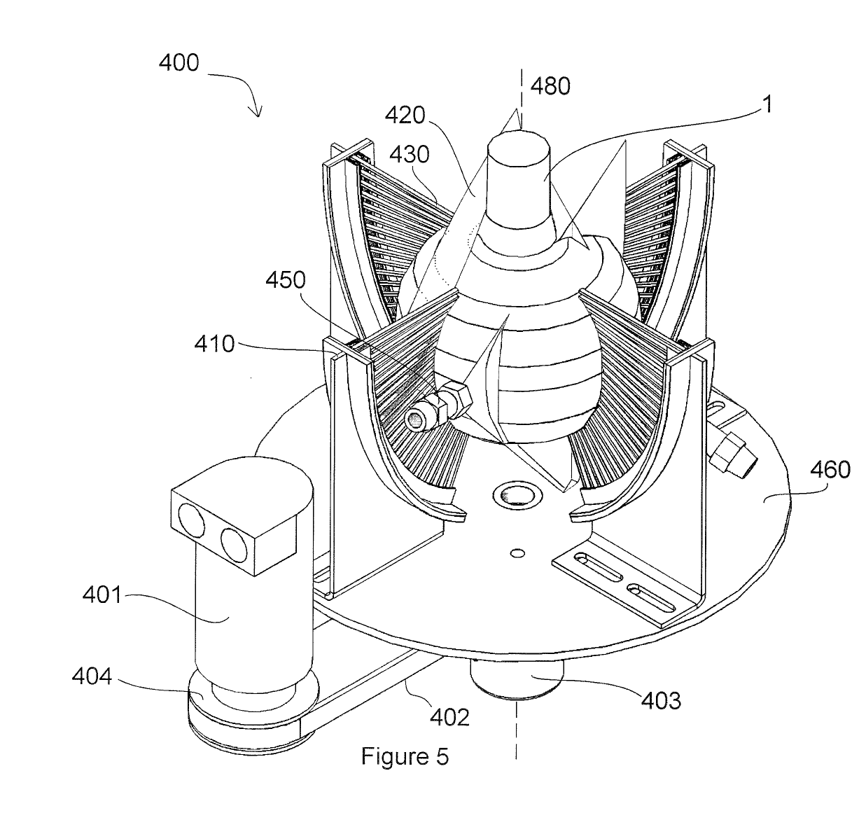

FIGS. 4 and 5 show an apparatus for improving the condition of frost-damaged artichokes, in accordance with an alternative embodiment of the present invention. Apparatus 400 may also function as Cleaning Section 320. In apparatus 400, at least one brush holder 410 is coupled to a base 460. Brush holder 410 holds brush 430. Brush 430 may comprise a brush, sponge, scraper, rag, blade, cloth material, a material that can apply a soft abrasion, or the like. Base 460 rotates around axis 480 and correspondingly, artichoke 1, being concentric with artichoke 1. Hydraulic drive motor 401 may be coupled to pulley 404. In the center 490 of base 406, pulley 405 is coupled to base 406. Pulleys 404 and 405 together with belt 402 form a drive which propels base 460 to rotate about axis 480. Coupled to pulley 405 may be rotary coupler 403 which may be used to pass a fluid stream to one or more sprayer nozzles 450. Sprayer nozzles 450 may be placed within apparatus 400 to direct a stream of fluid 420 on artichoke 1. Spray nozzles 450 may be fixed or movably placed. Further, one or more spray nozzles 450 may be positioned to conjunctively encompass an increased area of artichoke 1's globe. Spray nozzles 450 need not be supplied by a fluid stream provided by rotary coupler 403 and may be supplied with fluid by any device well known in the art.

As hydraulic drive motor 401 propel base 460 to rotate about axis 480, brushes 430 contact artichoke 1 to remove the frost-damages portions of artichoke 1. Further, spray nozzles 450 may rotate with base 460 or independently in addition or alternatively to brushes 430. Hydraulic drive motor 401 may be any type of motor sufficient to propel base 460, including a combustion engine, an electric motor or any similar device known in the art.

Information as herein shown and described in detail is fully capable of attaining the above-described object of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, in which reference to an element in the singular is not intended to mean “one and only one” unless explicitly so stated, but rather “one or more.”

All structural and functional equivalents to and combinations of the elements of the above-described preferred embodiment and additional embodiments that are known to those of ordinary skill in the art are hereby expressly incorporated by reference and are intended to be encompassed by the present claims. However, it should be readily apparent to those of ordinary skill in the art that various changes and modifications in form, apparatus material, and fabrication material detail may be made without departing from the spirit and scope of the invention as set forth in the appended claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. No claim herein is to be construed under the provisions of 35 U.S.C. §112, sixth paragraph, unless the element is expressly recited using the phrase “means for.”

### INDUSTRIAL APPLICABILITY

The present invention is industrially applicable to artichoke production. More specifically, the present invention is industrially applicable to cleaning frost-damaged artichokes.

What is claimed is:

1. A method for recovering a frost-damaged artichoke, said method having the following steps:
selecting at least one frost-damaged artichoke;
removing frost-damaged portions of said artichoke by directing a first fluid at the damaged portions of the artichoke thereof.

2. The method of claim 1 further comprising:
analyzing said artichoke's frost-damage, shape and or size;
varying said first fluid's pressure and direction based on said analysis.

3. The method of claim 1 wherein said directed first fluid utilizes a fixed or movable array of nozzles.

4. The method of claim 1 wherein said first fluid may be air, water, or a water-based solution.

5. A method for improving a frost-damaged artichoke, said method having the following steps:
selecting one or more frost-damaged artichokes;
wetting said artichokes;
removing mechanically frost-damaged portions of said artichokes.

6. The method of claim 5 whereby said wetting is by spraying said artichokes with a water based fluid or by submerging said artichokes in a water based fluid.

7. The method of claim 5 whereby said mechanical removal is by a brush or sponge.

8. The method of claim 7 further comprising the steps:
analyzing said artichokes frost-damage, size and or shape;
varying the duration, angle, length and or type of said brush or said sponge based on said analysis.

9. An apparatus for reconditioning frost-damaged portions of an artichoke comprising:
one or more brushes coupled to a base;
said base containing a center forming an axis;
said brushes placed to contact a void concentrically above said center along said axis;
a mount coupled to said base concentrically below said center along said axis;
a propelling device coupled to said mount for propelling said base.

10. The apparatus of claim 9 further comprising one or more spray nozzles positioned to direct a fluid at said void.

11. The apparatus of claim 10 further comprising a rotary coupler device coupled to said mount for providing said one or more nozzles fluid.

12. The apparatus of claim 9 wherein said propelling device is a hydraulic drive motor.
